(19) United States
(12) Patent Application Publication
(10) Pub. No.: US 2025/0215284 A1
(43) Pub. Date: Jul. 3, 2025

(54) RELEASE LINERS AND ADHESIVE ARTICLES HAVING VARIABLE LIGHT TRANSMITTANCE

(71) Applicant: 3M INNOVATIVE PROPERTIES COMPANY, St. Paul, MN (US)

(72) Inventors: Jason D. Clapper, Lino Lakes, MN (US); Daniel Carvajal, Edina, MN (US); Hyunki Kim, Woodbury, MN (US); Andrew T. Swanson, St. Paul, MN (US); Hollis Z. Beagi, Stillwater, MN (US)

(21) Appl. No.: 18/850,283

(22) PCT Filed: May 1, 2023
(86) PCT No.: PCT/IB2023/054518

§ 371 Date: Sep. 24, 2024

Related U.S. Application Data
(60) Provisional application No. 63/348,576, filed on Jun. 3, 2022.

(51) Int. Cl. C09J 7/40; C09J 7/38

(52) U.S. Cl. CPC C09J 7/405; C09J 7/385; C09J 2301/302; C09J 2301/312; C09J 2301/414; C09J 2301/416

(57) ABSTRACT

Release liners are provided, including a substrate having a first major surface and an opposing second major surface and a release coating disposed on at least a portion of the first major surface of the substrate. The release liners transmit a greater average of incident light over a wavelength range from 470 nanometers (nm) to 530 nm than over a wavelength range from 400 nm to 460 nm. Adhesive articles are also provided. Adhesive articles include a release liner and an optically clear adhesive disposed on at least a portion of the release liner.

### BACKGROUND

In electronic devices, e.g., electronic display devices, pressure-sensitive adhesives (“PSAs”) are commonly used to bond a cover glass or lens to the underlying display module of the electronic device, bond the touch sensor to the cover glass and the display, or bond the lower components of the display to the housing. The pressure-sensitive adhesives used in these electronic devices may be optically clear adhesives (“OCAs”).

The presence of an OCA can improve the performance of a display device, for example, by increasing brightness and contrast, while also providing structural support to the assembly. For these applications (commonly referred to as electronics bonding, or e-bonding), both the PSAs and the OCAs should have sufficiently high strength of adhesive force to properly maintain good adhesion to components, not only when the electronic devices are operating under normal conditions, but also when they are subjected to external forces or extreme environmental conditions.

### SUMMARY

In a first aspect, a release liner is provided. The release liner comprises a substrate having a first major surface and an opposing second major surface and a release coating disposed on at least a portion of the first major surface of the substrate. The release liner transmits at an incident light angle of at least one of 0°, 15°, 30°, 45°, 60°, or 75°, a greater average of incident light over a wavelength range from 470 nanometers (nm) to 530 nm than over a wavelength range from 400 nm to 460 nm.

In a second aspect, an adhesive article is provided. The adhesive article comprises a release liner according to the first aspect and an optically clear adhesive disposed on at least a portion of the release liner.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### BRIEF DESCRIPTION OF DRAWINGS

FIG. 1 is a schematic of a vertical cross-section of an exemplary release liner according to the present disclosure.

FIG. 2 is a schematic of a vertical cross-section of an exemplary adhesive article according to the present disclosure.

### DETAILED DESCRIPTION

### Glossary

The term “crosslinkable composition” refers to the reaction mixture that may be crosslinked. The crosslinkable composition may include polymerizable components plus any other material, such as, for example, a free-radical initiator, a chain transfer agent, an antioxidant, a solvent, and the like that may be included in the reaction mixture.

The term “curable” means that a solid material can be transformed into a more crosslinked solid by means of stimuli induced crosslinking.

The term “gel fraction” as used herein refers to the mass fraction of the network material resulting from a network-forming polymerization and/or crosslinking process.

The term “aliphatic” refers to C1-C40, suitably C1-C30, straight or branched chain alkenyl, alkyl, or alkynyl which may or may not be interrupted or substituted by one or more heteroatoms such as O, N, or S. The term “cycloaliphatic” refers to cyclized aliphatic C3-C30, suitably C3-C20, groups and includes those interrupted by one or more heteroatoms such as O, N, or S.

The term “alkyl” refers to a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Examples of “alkyl” groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, norbornyl, and the like.

The term “alkoxy” refers to a monovalent group of formula —OR^{a} where R^{a} is an alkyl as defined above.

The term “alkylene” refers to a divalent group that is a radical of an alkane and includes groups that are linear, branched, cyclic, bicyclic, or a combination thereof. Unless otherwise indicated, the alkylene group typically has 1 to 30 carbon atoms. In some embodiments, the alkylene group has 1 to 20 carbon atoms, 1 to 10 carbon atoms, 1 to 6 carbon atoms, or 1 to 4 carbon atoms. Examples of “alkylene” groups include methylene, ethylene, 1,3-propylene, 1,2-propylene, 1,4-butylene, 1,4-cyclohexylene, and 1,4-cyclohexyldimethylene.

The term “heteroalkylene” refers to a divalent radical of a heteroalkane, which is an alkane having catenary heteroatoms having at least one catenary O or NH group. Unless otherwise indicated, the heteroalkylene group typically has 1 to 10 carbon atoms, 2 to 10 carbon atoms, 1 to 6 carbon atoms, 1 to 4 carbon atoms, or 1 to 3 carbon atoms, and up to 6 heteroatoms.

Each of “alkenyl” and “ene” refers to a monovalent linear or branched unsaturated aliphatic group with one or more carbon-carbon double bonds, e.g., vinyl.

The term “aromatic” refers to C3-C40, suitably C3-C30, aromatic groups including both carbocyclic aromatic groups as well as heterocyclic aromatic groups containing one or more of the heteroatoms, O, N, or S, and fused ring systems containing one or more of these aromatic groups fused together.

The term “aryl” refers to a monovalent group that is aromatic and, optionally, carbocyclic. The aryl has at least one aromatic ring. Any additional rings can be unsaturated, partially saturated, saturated, or aromatic. Optionally, the aromatic ring can have one or more additional carbocyclic rings that are fused to the aromatic ring. Unless otherwise indicated, the aryl groups typically contain from 6 to 30 carbon atoms. In some embodiments, the aryl groups contain 6 to 20, 6 to 18, 6 to 16, 6 to 12, or 6 to 10 carbon atoms. Examples of an aryl group include phenyl, naphthyl, biphenyl, phenanthryl, and anthracyl.

The term “arylene” refers to a divalent group that is aromatic and, optionally, carbocyclic. The arylene has at least one aromatic ring. Optionally, the aromatic ring can have one or more additional carbocyclic rings that are fused to the aromatic ring. Any additional rings can be unsaturated, partially saturated, or saturated. Unless otherwise specified, arylene groups often have 6 to 20 carbon atoms, 6 to 18 carbon atoms, 6 to 16 carbon atoms, 6 to 12 carbon atoms, or 6 to 10 carbon atoms.

The term “aralkyl” refers to a monovalent group that is an alkyl group substituted with an aryl group (e.g., as in a benzyl group). The term “alkaryl” refers to a monovalent group that is an aryl substituted with an alkyl group (e.g., as in a tolyl group). Unless otherwise indicated, for both groups, the alkyl portion often has 1 to 10 carbon atoms, 1 to 6 carbon atoms, or 1 to 4 carbon atoms and the aryl portion often has 6 to 20 carbon atoms, 6 to 18 carbon atoms, 6 to 16 carbon atoms, 6 to 12 carbon atoms, or 6 to 10 carbon atoms.

The term “aryloxy” refers to a monovalent group that is of formula —OAr where Ar is an aryl group as defined above.

As used herein, the term “ethylenically unsaturated” refers to a group that comprises at least one carbon-carbon double bond, including at least one of (1) a vinyl group (CH2=CH—); (2) a (meth)acryloyloxy group (CH2=CR—(CO)—O—), wherein R is hydrogen or methyl); or (3) a (meth)acrylamido group (CH2=CR—(CO)—NH—), wherein R is hydrogen or methyl; or a maleic group (—(CO)—(CH═CH)—(CO)—).

The term “hydrocarbyl” is inclusive of aryl and alkyl. “Hydrocarbylene” is inclusive of arylene and alkylene.

As used herein, the term “(meth)acrylate” is a shorthand reference to acrylate, methacrylate, or combinations thereof, “(meth)acrylic” is a shorthand reference to acrylic, methacrylic, or combinations thereof, and “(meth)acryl” is a shorthand reference to acryl and methacryl groups. “Acryl” refers to derivatives of acrylic acid, such as acrylates, methacrylates, acrylamides, and methacrylamides. By “(meth)acryl” is meant a monomer or oligomer having at least one acryl or methacryl group, and linked by an aliphatic segment if containing two or more groups. As used herein, “(meth)acrylate-functional compounds” are compounds that include, among other things, a (meth)acrylate moiety. The term “(meth)acryloyl” refers to a group of formula CH₂═CR—(CO)— where R is hydrogen (for an acryloyl group) or methyl (for a methacryloyl group). Likewise, the term “(meth)allyl group” refers to a methallyl group and/or an allyl group.

The term “vinyl” refers to a polymerizable component that has a group CH₂—CH— but that is not part of a (meth)acryloyl group.

As used herein, “C1”, “1C”, and “1 carbon” are interchangeable ways of describing a single carbon atom and may be used interchangeably when indicating any number of carbon atoms.

The term “glass transition temperature”, which can be written interchangeably as “T_{g}”, of a monomer refers to the glass transition temperature of the homopolymer formed from the monomer. The glass transition temperature for a polymeric material is typically measured by Dynamic Mechanical Analysis (“DMA”) at the maximum in tan delta (8).

The term “optically clear adhesive”, as used herein, refers to an adhesive that exhibits an optical transmission of visible light (e.g., 400 nm to 700 nm) of at least about 80%, as measured on a sample having a thickness from about 25 micrometers to about 250 micrometers. In some embodiments, the optical transmission may be at least about 85%, 90%, 95% or even higher.

As used herein, the term “transparent” refers to a material that has at least 50% transmittance, 70% transmittance, or optionally greater than 90% transmittance over at least a 30 nanometer (nm) wavelength band within a particular range of wavelengths and has a thickness of 10 millimeters or less. Suitable ranges of wavelengths include for instance, between 200 nm and 400 nm, between 400 nm and 700 nm, or between 700 nm and 1300 nm.

The term “pressure-sensitive adhesive” or “PSA” is used in its conventional manner according to the Pressure-Sensitive Tape Council, which states that pressure-sensitive adhesives are known to possess properties including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as PSAs include polymers designed and formulated to exhibit the requisite viscoelastic properties resulting in a desired balance of tack, peel adhesion, and shear holding power. PSAs are characterized by being normally tacky at room temperature (e.g., 20° C.). Central to all PSAs is a desired balance of adhesion and cohesion that is often achieved by optimizing the physical properties of the elastomer, such as glass transition temperature and modulus. For example, if the glass transition temperature (T_{g}) or modulus of the elastomer is too high and above the Dahlquist criterion for tack (storage modulus of 3×10⁶ dynes/cm² at room temperature and oscillation frequency of 1 Hz), the material will not be tacky and is not useful by itself as a PSA material.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.”

The phrases “at least one of” and “comprises at least one of”′ followed by a list refers to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

The advantages of using an optically clear adhesive (“OCA”) in optoelectronic devices may include, inter alia, an enhancement of the light extraction efficiencies between various optical components of the display and reduction of light scattering by mitigating refractive index mismatches at interfaces. As topographical features of optoelectronic device structures evolve into more complex geometries, there is an increasing demand for the development of highly compliant OCAs that can both adjust to these complex geometries as well as mitigate optical defects. However, once OCA film is integrated into the display, the OCA material should also be mechanically robust for the lifetime of the device in order to provide high mechanical stability and performance. One method of balancing these potentially opposing manufacturing requirements is to incorporate latent curing mechanisms that can be activated by a user (e.g., typically a display manufacturer) to increase the mechanical stability and performance of the adhesive film after it is integrated into the display.

For some applications, it may also be desirable for an OCA material to utilize UV-absorbing additives to protect any UV-sensitive components underneath the OCA layer. For example, hydroxyphenyl benzotriazole-based UV absorbers, which show high absorption below 400 nm wavelength of light, may be incorporated into OCAs to block UV light from reaching light-sensitive layers adjacent to the adhesive. However, this UV-absorbing function may intervene with a user's ability to utilize UV irradiation to further cure the adhesive once it is in the display. Reduced access to the post-lamination curing process not only limits the adhesive's ability to balance compliance with robust lifetime reliability but may also limit the adhesive and mechanical performance attributes of the OCA in general. Therefore, certain recent technological development in OCA materials have moved to create latent curing mechanisms that may be triggered with irradiation in the visible spectrum so as not to be competing with the UV-blocking functionality. This functionality, however, may make the latent cure chemistry more susceptible to ambient light during the handling and lamination stages of integration, which is undesirable.

OCAs are typically delivered to a user as die-cut parts between release liner carriers. The liners are stripped off in subsequent steps during the integration process as each surface of the OCA is laminated to different parts of the display construction. The present disclosure pairs an OCA with a release liner that protects the OCA from specific wavelengths that would activate the cure prematurely. In some cases, the OCA is a UV blocking, visible light curable OCA. This liner may serve to protect the latent cure mechanism during the shipping and handling of the adhesive die-cut parts, but also during integration processes, such as processes in which the adhesive is laminated to one side of a display construction as that assembly is further handled in the manufacturing facility.

### Release Liners

In a first aspect, a release liner is provided. The release liner comprises:
a) a substrate having a first major surface and an opposing second major surface; and
b) a release coating disposed on at least a portion of the first major surface of the substrate,
wherein the release liner transmits at an incident light angle of at least one of 0°, 15°, 30°, 45°, 60°, or 75°, a greater average of incident light over a wavelength range from 470 nanometers (nm) to 530 nm than over a wavelength range from 400 nm to 460 nm.

In some cases, the release liner transmits (at an incident light angle of at least one of 0°, 15°, 30°, 45°, 60°, or) 75°, at least a 10% greater average of incident light over a wavelength range from 470 nm to 530 nm than over a wavelength range from 400 nm to 460 nm, 15%, 20%, 25%, 30%, 35%, or at least a 40% greater average of incident light over a wavelength range from 470 nm to 530 nm than over a wavelength range from 400 nm to 460 nm; and up to a 90% greater average of incident light over a wavelength range from 470 nm to 530 nm than over a wavelength range from 400 nm to 460 nm.

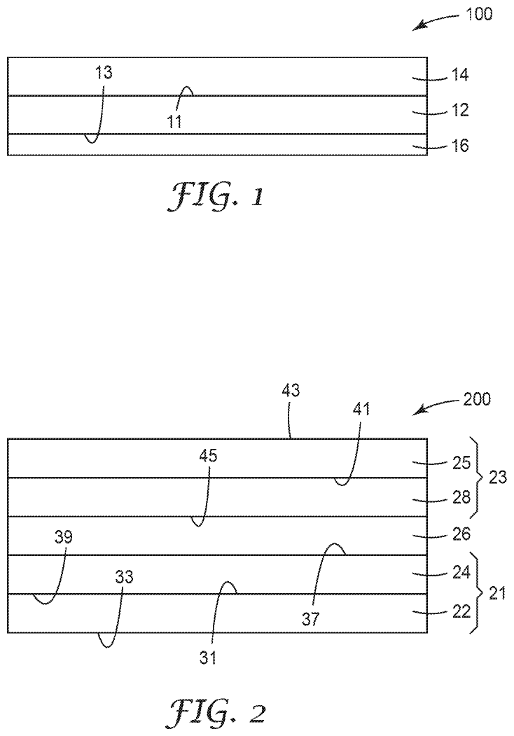

Referring to FIG. 1, a release liner 100 comprises a substrate 12 having a first major surface 11 and an opposing second major surface 13; and a release coating 14 disposed on at least a portion of the first major surface 11 of the substrate 12.

Often, the substrate comprises a polymeric film. Exemplary suitable substrate materials include for instance and without limitation, polyimide, polyethylene terephthalate (PET), polypropylene (PP), biaxially oriented polypropylene (BOPP), polyethylene (PE), polylactic acid (PLA), polymethyl methacrylate (PMMA), polyethylene naphthalate (PEN), polyurethane, polyvinyl chloride (PVC), polyvinyl alcohol (PVA), polyvinyl butyral, cellulose acetate, or any combination thereof. In some cases, a preferred substrate material comprises PET, PE, PP, and/or BOPP.

Often, polyimide has a yellow coloration to it, thus is not completely transparent to visible light. for instance, yellow materials typically absorb light in the 420 nm to 430 nm range. It was unexpectedly discovered that a release liner including a substrate comprising polyimide was effective to block (e.g., absorb) at least some wavelengths that would activate cure of an adhesive prematurely, while still being sufficiently transparent for adhesive quality control monitoring and defect inspection through the polyimide (e.g., for particles and/or bubbles in the adhesive, such as using optical equipment). Polyimide may be a preferred substrate material in certain applications.

Many polymeric materials lack sufficient absorption of wavelengths to block premature adhesive curing. However, one or more photoabsorbers may be used in combination with a (e.g., transparent) substrate to impart the desired photoabsorbent properties of the release liner substrate. Polymeric substrate materials with which photoabsorbers may be used include for instance, PET, PP, BOPP, PE, PLA, PMMA, PEN, polyurethane, PVC, PVA, polyvinyl butyral, and cellulose acetate, to name a few.

For example, a photoabsorber may be incorporated into the substrate or present in a coating on the second major surface of the substrate (opposite the release coating). Referring again to FIG. 1, a coating 16 comprising a photoabsorber is disposed on at least a portion of the second major surface 13 of the substrate 12. Useful photoabsorbers may include a photoabsorber additive comprising a dye, a pigment, a red shifted ultraviolet absorber, nanoparticles (e.g., inorganic nanoparticles), or any combination thereof. Typical photoabsorber additive loading level in a polymeric material is 2-10 wt. % of the total weight of the substrate and photoabsorber additive.

For instance, suitable photoabsorber additives include commercial products such as “TINUVIN CARBOPROTECT” (BASF, Florham Park, NJ) or dyes such as tartrazine (Fischer Scientific, Waltham, MA) and sodium copper chlorophyllin (TCI Chemicals, Tokyo, Japan), to name a few. Exemplary suitable nanoparticles include carbon black, titanium dioxide, zinc oxide, cesium dioxide, zirconium dioxide, or combinations thereof. These particular nanoparticles tend to be stable to ultraviolet radiation in addition to absorbing the radiation.

Some suitable red shifted UV absorbers (RUVAs) absorb at least 70% (in some embodiments, at least 80%, or even greater than 90%) of the UV light in the wavelength region from 180 nm to 430 nm. RUVAs typically have enhanced spectral coverage in the long-wave UV region, enabling it to block high wavelength UV light. One of the most effective RUVA is a benzotriazole compound, 5-trifluoromethyl-2-(2-hydroxy-3-alpha-cumyl-5-tert-octylphenyl)-2H-benzotriazole (available under the trade designation “CGL-0139” from BASF). Other exemplary benzotriazoles include 2-(2-hydroxy-3,5-di-alpha-cumylphehyl)-2H-benzotriazole, 5-chloro-2-(2-hydroxy-3-tert-butyl-5-methylphenyl)-2H-benzotiazole, 5-chloro-2-(2-hydroxy-3,5-di-tert-butylphenyl)-2H-benzotriazole, 2-(2-hydroxy-3,5-di-tert-amylphenyl)-2H-benzotriazole, 2-(2-hydroxy-3-alpha-cumyl-5-tert-octylphenyl)-2H-benzotriazole, 2-(3-tert-butyl-2-hydroxy-5-methylphenyl)-5-chloro-2H-benzotriazole. Further exemplary RUVAs includes 2 (-4,6-diphenyl-1-3,5-triazin-2-yl)-5-hexyloxy-phenol. Other exemplary UV absorbers include those available from BASF under the trade designations “TINUVIN 1577,” “TINUVIN 900,” “TINUVIN 1600,” and “TINUVIN 777.” Other exemplary UV absorbers are available, for example, in a polyester master batch under the trade designation “TA07-07 MB” from Sukano Polymers Corporation, Dunkin, SC. An exemplary UV absorber for polymethylmethacrylate is a masterbatch available, for example, under the trade designation “TA11-10 MBO1” from Sukano Polymers Corporation.

The release coating for use in the release liner is not particularly limited. Often, the release coating comprises a material selected from the group consisting of a fluorine-containing material, a silicone-containing material, a fluoropolymer, a silicone polymer, a fluorosilicone polymer, and a poly(meth)acrylate ester derived from a monomer including an alkyl (meth)acrylate having an alkyl group with 12 to 36 carbon atoms. In one embodiment, the alkyl group on the alkyl (meth)acrylate can be branched. Illustrative examples of useful fluoropolymers and silicone polymers can be found in U.S. Pat. No. 4,472,480 (Olson), U.S. Pat. Nos. 4,567,073 and 4,614,667 (both Larson et al.). Illustrative examples of useful poly(meth)acrylate esters can be found in U.S. Pat. Appl. Publ. No. 2005/118352 (Suwa). Release coatings can be applied to a substrate by solvent or solvent-free methods.

Preferably, release liners according to the present disclosure absorb, at an incident light angle of at least one of 0°, 15°, 30°, 45°, 60°, or 75°, an average of at least 10% of incident light over a wavelength range from at least 400 nm to 450 nm. In select embodiments, an exemplary release liner transmits, at an incident light angle of at least one of 0°, 15°, 30°, 45°, 60°, or 75°, an average of at least 30 percent, 35 percent, 40 percent, 45 percent, or at least 50 percent of incident light over a wavelength range from 500 nm to 595 nm; and an average of at most 90 percent, 85 percent, 80 percent, 75 percent, or at most 70 percent of incident light over a wavelength range of 400 nm to 450 nm.

### Adhesive Articles

In a second aspect, an adhesive article is provided. The adhesive article comprises:
a) a release liner according to any of the embodiments of the release liner of the first aspect described in detail above; and
b) an optically clear adhesive disposed on at least a portion of the release liner.

Referring to FIG. 2, an adhesive article 200 comprises a release liner 21 and an optically clear adhesive 26 disposed on at least a portion of the release liner 21. The release liner 21 comprises a substrate 22 having a first major surface 31 and an opposing second major surface 33; and a release coating 24 disposed on at least a portion of the first major surface 31 of the substrate 22. The optically clear adhesive 26 is located on at least a portion of a first major surface 37 of the release coating 24 of the release liner 21. Often, a layer of the optically clear adhesive 26 has a thickness in a range from 100 to 250 (in some embodiments, in a range from 125 to 200) micrometers, although other thicknesses may be useful.

In some embodiments, the release liner 21 is a first release liner and the adhesive article 200 comprises a second release liner 23 disposed on the optically clear adhesive 26 opposite the first release liner 21. In some cases, the second release liner 23 is different from the first release liner 21 in some aspect of its construction (e.g., specific substrate and/or release coating), whereas in other cases the second release liner 23 is the same as the first release liner (e.g., according to any of the embodiments of the first aspect described above in detail). For instance, the second release liner 23 depicted in FIG. 2 comprises a substrate 25 having a first major surface 41 and an opposing second major surface 43; and a release coating 28 disposed on at least a portion of the first major surface 41 of the substrate 25. The optically clear adhesive 26 has a first major surface 45 opposite the first major surface 37 of the release coating 24 of the release liner 21, and the release coating 28 of the second release liner 23 is in contact with the first major surface 45 of the optically clear adhesive 26 opposite the substrate 25 of the second release liner 23.

In some cases, it is advantageous to include two release liners that block at least some incident light over a wavelength range from 400 nm to 460 nm, particularly when the adhesive article may be exposed to ambient light prior to use in an article. In other cases, only one release liner that blocks such incident light is required as in some applications the second release liner is removed promptly and the optically clear adhesive adhered to an article, which may itself block at least some incident light over a wavelength range from 400 nm to 460 nm.

Preferably, the optically clear adhesive has a haze value of less than 7%, less than 5%, less than 2%, or less than 1%, for a 0.1 mm thick coating (e.g., layer) of the optically clear adhesive. Haze value may be measured using a haze meter obtained under the trade designation “HAZE-GARD PLUS” from BYK-Gardner, Columbia, MD.

Optionally, an optically clear adhesive (OCA) is a pressure-sensitive adhesive. In certain embodiments, a suitable OCA is selected from an acrylate, a polyurethane, a polyolefin (such as a polyisobutylene (PIB)), a silicone, or a combination thereof. Illustrative OCAs include those described in International Pub. No. WO 2008/128073 (Everaerts et al.) relating to antistatic optically clear pressure-sensitive adhesives, U.S. Pat. App. Pub. Nos. US 2009/089137 (Sherman et al.) relating to stretch releasing OCA, US 2009/0087629 (Everaerts et al.) relating to indium tin oxide compatible OCA, US 2010/0028564 (Cheng et al.) relating to antistatic optical constructions having optically transmissive adhesive, US 2010/0040842 (Everaerts et al.) relating to adhesives compatible with corrosion sensitive layers, US 2011/0126968 (Dolezal et al.) relating to optically clear stretch release adhesive tape, and U.S. Pat. No. 8,557,378 (Yamanaka et al.) relating to stretch release adhesive tapes. Suitable OCAs include acrylic optically clear pressure-sensitive adhesives such as, for example, 3M OCA 8146, 8211, 8212, 8213, 8214, and 8215, each available from 3M Company, St. Paul, MN.

In some embodiments, a suitable optically clear adhesive comprises a (meth)acrylate copolymer and a reactive crosslinker. Exemplary reactive crosslinkers include multifunctional components such as multifunctional acrylates. The term “multifunctional” as used herein refers to crosslinkers which possess two or more free radically polymerizable ethylenically unsaturated groups. Particularly useful multifunctional crosslinkers include those selected from the group consisting of acrylic or methacrylic esters of diols such as butanediol, triols such as glycerol, and tetraols such as pentaerythritol. Other useful crosslinkers include those selected from the group consisting of other multifunctional vinyl compounds and multifunctional acrylated oligomers. Preferred crosslinkers include those selected from the group consisting of multifunctional (meth)acrylates, e.g., 1,4-butanediol diacrylate or 1,6-hexanediol diacrylate; pentaerythritol tetra acrylate; polyvinylic crosslinkers, such as substituted and unsubstituted divinylbenzene, polybutadiene diacrylate, or polyisoprene diacrylate; and difunctional urethane acrylates, such as “EBECRYL 270” and “EBECRYL 230” (1500 weight average molecular weight and 5000 weight average molecular weight acrylated polyurethanes, respectively-both available from Allnex, Alpharetta, Georgia).

In some embodiments, a suitable optically clear adhesive comprises a (meth)acrylate copolymer having pendant (meth)acryloyl groups and optionally pendant hydroxyl groups (e.g., compounded with a free-radical generating photoinitiator). The (meth)acrylate copolymer may have a weight average molecular weight of 50,000 to 600,000 Daltons and an average molecular weight between (meth)acryloyl groups equal to at least 16,000 Daltons.

In some embodiments, the optically clear adhesive may be resistant to ultraviolet radiation damage. For instance, the optically clear adhesive may further comprise a UV absorber. Exemplary adhesives which are typically resistant to ultraviolet radiation damage include silicone adhesives and acrylic adhesives containing UV-stabilizing/blocking additive(s), for example. U.S. Pat. No. 5,504,134 (Palmer et al.), for instance, describes attenuation of polymer substrate degradation due to ultraviolet radiation through the use of metal oxide particles in a size range of about 0.001 to about 0.2 micrometers (in some embodiments, about 0.01 micrometers to about 0.15 micrometers) in diameter. U.S. Pat. No. 5,876,688 (Laundon), describes a method for producing micronized zinc oxide that are small enough to be transparent when incorporated as UV blocking and/or scattering agents in paints, coatings, finishes, plastic articles, cosmetics and the like which are well suited for use in the present invention. These fine particles such as zinc oxide and titanium oxide with particle sizes ranging from 10 nm to 100 nm that can attenuate UV radiation are available, for example, from Kobo Products, Inc., South Plainfield, NJ. Typically, a suitable UV absorber absorbs at least in a wavelength range of 300 nm to 400 nm.

Suitable photoinitiator compounds for use herein may be easily identified by those skilled in the art in the light of the present disclosure. Preferably, the photoinitiator is activated by light having wavelengths of at least 350 nm. Also, it is preferred that the photoinitiator is activated by light having wavelengths of up to 750 nm. Accordingly, it is preferred that the photoinitiator is activated by light having wavelengths in the range of from 350 nm to 750 nm, preferably from 380 to 700 nm, more preferably from 400 to 460 nm. That is, the photoinitiator may be activated by light having wavelengths in the range of from 380 to 460 nm, and/or 400 to 430 nm, and/or from 450 to 485 nm, and/or from 450 to 495 nm.

A suitable photoinitiator may be selected from the group consisting of Norrish type (I) free-radical polymerization initiators, Norrish type (II) free-radical polymerization initiators, and any combinations or mixtures thereof. Exemplary suitable photoinitiators include for instance and without limitation, alpha-diketones and/or phosphinoxides, preferably from camphorquinone, acylphosphinoxide, phenyl-propane-dione, acrylphosphinoxide, dibenzoyl, 1-phenyl-1,2-propandione, and any mixtures and combinations thereof. In some cases, the photoinitiator is preferably camphorquinone.

In select embodiments, the optically clear adhesive comprises a crosslinkable composition comprising:
a) a (meth)acrylate polymer comprising an alkyl (meth)acrylate monomer;
b) an acylphosphine oxide photoinitiator; and
c) a crosslinking monomer, the crosslinking monomer comprising at least two terminal groups selected from the group consisting of allyl, methallyl, or combinations thereof.

Such an OCA provides UV-absorbing and post-lamination curable OCA films produced using a scheme that takes advantage of a combination of rapidly polymerizing acrylic monomers in conjunction with more slowly reacting crosslinker compounds. This scheme allows for greater separation between the polymerization and crosslinking functions of the adhesive without requiring multiple wavelength emission equipment, while concurrently allowing for the achievement of both functions in the presence of UV absorber additives.

The (meth)acrylate polymer can be prepared from polymerizable components including an alkyl (meth)acrylate monomer using known polymerization methods.

### Alkyl (Meth)Acrylate Monomers

Any suitable alkyl (meth)acrylate or mixture of alkyl (meth)acrylates can be used provided the glass transition temperature of the final (meth)acylate polymer is sufficiently low (e.g., no greater than 20° C.). Some alkyl (meth)acrylate monomers can be classified as low T_{g} monomers based on the glass transition temperature of the corresponding homopolymers. The low T_{g} monomers, as measured from the corresponding homopolymers, often have a T_{g} no greater than 20° C., no greater than 10° C., no greater than 0° C., or no greater than −10° C.

Suitable low T_{g} alkyl (meth)acrylate monomers include, but are not limited to, non-tertiary alkyl acrylates but can be an alkyl methacrylate having a linear alkyl group with at least four carbon atoms. Specific examples of alkyl (meth)acrylates include, but are not limited to, methyl acrylate, ethyl acrylate, n-propyl acrylate, n-butyl acrylate, n-butyl methacrylate, isobutyl acrylate, sec-butyl acrylate, n-pentyl acrylate, 2-methylbutyl acrylate, n-hexyl acrylate, cyclohexyl acrylate, 4-methyl-2-pentyl acrylate, 2-methylhexyl acrylate, 2-ethylhexyl acrylate, n-octyl acrylate, 2-octyl acrylate, isooctyl acrylate, isononyl acrylate, isoamyl acrylate, n-decyl acrylate, isodecyl acrylate, n-decyl methacrylate, lauryl acrylate, isotridecyl acrylate, n-octadecyl acrylate, isostearyl acrylate, n-dodecyl methacrylate, and combinations thereof. In some embodiments, the low T_{g} alkyl (meth)acrylates is selected from 2-ethylhexyl acrylate, isooctyl acrylate, n-butyl acrylate, 2-methylbutyl acrylate, 2-octyl acrylate, and combinations thereof. Other suitable monomers include branched long chain acrylates, such as those described in U.S. Pat. No. 8,137,807 (Clapper, et al.). Additional suitable alkyl monomers include secondary alkyl acrylates, such as those described in U.S. Pat. No. 9,102,774 (Clapper, et al.).

Other alkyl (meth)acrylates that can be included in the polymerizable components are classified as high T_{g} monomers based on the glass transition temperature of the corresponding homopolymers. The high T_{g} monomers often have a T_{g} greater than 30° C., greater than 40° C., or greater than 50° C. when homopolymerized (i.e., a homopolymer formed from the monomer has a T_{g} greater than 30° C., greater than 40° C., or greater than 50° C.). Some suitable high T_{g} alkyl (meth)acrylate monomers include, for example, methyl methacrylate, ethyl methacrylate, n-propyl methacrylate, isopropyl methacrylate, n-butyl methacrylate, isobutyl methacrylate, sec-butyl methacrylate, tert-butyl (meth)acrylate, cyclohexyl methacrylate, isobornyl (meth)acrylate, stearyl (meth)acrylate, and 3,3,5 trimethylcyclohexyl (meth)acrylate.

The amount of the alkyl (meth)acrylate incorporated into the (meth)acrylate polymer can be any suitable amount up to 100 weight percent based on the total weight of the (meth)acrylic polymerizable components. The amount of the alkyl (meth)acrylate is often at least 35 weight percent, at least 40 weight percent, at least 45 weight percent, or at least 50 weight percent.

If the alkyl (meth)acrylate is selected to include high T_{g} monomers, the amount of this monomer is often no greater than 40 weight percent based on the total weight of polymerizable components. That is, the amount can be in a range of 0 to 40 weight percent based on the total weight of polymerizable components. If higher amounts are used, the overall T_{g} of the (meth)acrylate polymer may be too high. The amount of the high T_{g} alkyl (meth)acrylate monomer is often no greater than 35 weight percent, no greater than 25 weight percent, or no greater than 15 weight percent. If present, the amount of the high T_{g} alky (meth)acrylate monomer is often at least 0.5 weight percent, at least 1 weight percent, at least 3 weight percent, at least 5 weight percent, or at least 10 weight percent. If the polymerizable component includes high T_{g} alkyl (meth)acrylate monomers, enough low T_{g} alkyl (meth)acrylate monomers is typically added to form a (meth)acylate polymer with a T_{g} no greater than 20° C.

The alkyl (meth)acrylate monomer is typically selected to include a low T_{g} monomer such as those that have a T_{g} no greater than −10° C. when measured as a homopolymer. For example, the polymerizable components often contain at least 40 weight percent, 45 weight percent, 50 weight percent, 55 weight percent, 60 weight percent, 65 weight percent, or at least 70 weight percent and up to 95 weight percent, 90 weight percent, 85 weight percent, 80 weight percent, 75 weight percent, or up to 70 weight percent low T_{g} monomer having a T_{g} no greater than −10° C. when measured as a homopolymer. The amount is based on the total weight of polymerizable components.

Suitable alkyl monomers that have a T_{g} no greater than −10° C. when measured as a homopolymer include, but are not limited to, 2-ethylhexyl acrylate, isooctyl acrylate, N-butyl acrylate, 2-methylbutyl acrylate, 2-octyl acrylate, and combinations thereof.

In some preferred embodiments, the alkyl (meth)acrylate monomer may be selected from the group consisting of 2-ethylhexyl acrylate, 2-ethylhexyl methacrylate, hexyl acrylate, butyl acrylate, cyclohexyl acrylate, isobornyl (meth)acrylate, and combinations thereof.

### Additional Monomers

In some embodiments, the (meth)acrylate polymer may include a hydroxyl (meth)acrylate comonomer. Examples of suitable monomers include but are not limited to: 2-hydroxyethyl (meth)acrylate, and 2-hydroxy-propyl (meth)acrylate, 4-hydroxybutyl (meth)acrylate, and the like. In some embodiments, the (meth)acrylate polymer includes between about 0 and about 40 parts by weight of the hydroxy functional copolymerizable monomer, between about 5 and about 35 parts, or between about 10 and about 30 parts.

In some embodiments, the (meth)acrylate polymer may include a non-hydroxy functional polar copolymerizable monomer. Examples of suitable non-hydroxy functional polar copolymerizable monomers include, but are not limited to: acrylic acid, methacrylic acid, itaconic acid, fumaric acid, ether functional monomers such as 2-ethoxyethyl (meth)acrylate, 2-ethoxyethoxyethyl (meth)acrylate, dimethylaminoethyl (meth)acrylate, nitrogen containing monomers such as acrylamide, methacrylamide, N-alkyl substituted and N,N-dialkyl substituted acrylamides or methacrylamides where the alkyl group has up to 3 carbons, and N-vinyl lactams. Examples of suitable substituted amide monomers include, but are not limited to: N,N-dimethylacrylamide, N,N-diethyl acrylamide, N-morpholino (meth)acrylate, N-vinyl pyrolidone and N-vinyl caprolactam. In some embodiments, the (meth)acrylate polymer includes between about 0 and about 20 parts by weight of the polar copolymerizable monomer, particularly between about 1 and about 15 parts, and more particularly between about 1 and about 10 parts.

In some embodiments, the (meth)acrylate polymer may include a vinyl ester, and particularly a C1 to C10 vinyl ester. An example of commercially available suitable vinyl esters include but are not limited to: vinyl acetate and VEOVA 9 or VEOVA 10 (available from Momentive Specialty Chemicals, New Smyrna Beach, Florida). The vinyl ester is typically added to the monomer mixture in an amount of between about 1 parts and about 20 parts by weight, particularly between about land about 15 parts, and more particularly between about 1 and about 10 parts. Other monomers, such as styrenic monomers may also be used.

In some embodiments, the (meth)acrylate polymer may include a polar (meth)acrylate monomer. Examples of suitable polar (meth)acrylate monomers include, but are not limited to: hydroxyethyl acrylate, hydroxypropyl acrylate, hydroxylbutyl acrylate, tetrahydrofuryl acrylate, acrylamide, N,N-dimethyl acrylamide, N-vinyl pyrrolidone, and acrylic acid. In some embodiments, the (meth)acrylate polymer includes between about 0 and about 50 parts by weight of the polar (meth)acrylate monomer, particularly between about 5 and about 45 parts, and more particularly between about 10 and about 40 parts.

In some embodiments, the (meth)acrylate polymer may include a monofunctional non-(meth)acrylate vinyl monomer. Examples of suitable monofunctional non-(meth)acrylate vinyl monomers include but are not limited to: N-vinyl pyrrolidone, N-vinyl carbazole, vinyl acetate, and vinyl ether. In some embodiments, the (meth)acrylate polymer includes between about 0 and about 15 parts by weight of the monofunctional non-(meth)acrylate vinyl monomer, particularly between about 1 and about 10 parts, and more particularly between about 1 and about 8 parts.

In some embodiments, the (meth)acrylate polymer may include a multifunctional (meth)acrylate monomer. Examples of useful multifunctional (meth)acrylate monomers include, but are not limited to, di(meth)acrylates, tri (meth)acrylates, and tetra(meth)acrylates, such as, for example, 1,6-hexanediol di(meth)acrylate, poly(ethylene glycol) di(meth)acrylates, polybutadiene di(meth)acrylate, polyurethane di(meth)acrylates, and propoxylated glycerin tri (meth)acrylate, and mixtures thereof. If used, the multifunctional (meth)acrylate monomer is typically used in an amount of at least 0.01, 0.02, 0.03, 0.04, or 0.05 up to 1, 2, 3, 4, or 5 parts by weight, relative to 100 parts by weight of the total monomer content.

In some preferred embodiments, the (meth)acrylate polymer may include 0 wt. % to 50 wt. % (e.g., 10 wt. % to 40 wt. %) of a polar (meth)acrylate monomer selected from the group consisting of hydroxyethyl acrylate, hydroxypropyl acrylate, hydroxylbutyl acrylate, tetrahydrofuryl acrylate, acrylamide, N,N-dimethyl acrylamide, N-vinyl pyrrolidone, acrylic acid, and combinations thereof; and 0 wt. % to 10 wt. % (e.g., 0 wt. % to 5 wt. %) of a monofunctional non-(meth)acrylate vinyl monomer selected from the group consisting of N-vinyl pyrrolidone, N-vinyl carbazole, vinyl acetate, vinyl ether, and combinations thereof.

### (Meth)Allyl Crosslinking Monomer

The crosslinkable composition further comprises a crosslinking monomer comprising at least two terminal groups selected from allyl, (meth)allyl, or combinations thereof. An allyl group has the structural formula H₂C═CH—CH₂—. It consists of a methylene bridge (—CH₂—) attached to a vinyl group (—CH═CH₂). Similarly, a (meth)ally group is a substituent with the structural formula H₂C═C(CH₃)—CH₂—.

In some embodiments, the crosslinking monomers are free of vinyl groups, such as vinyl ethers. Vinyl, also known as ethenyl, is the functional group —CH—CH₂, namely the ethylene molecule (H₂C═CH₂) minus one hydrogen atom.

In one embodiment, the crosslinking monomer comprise two (meth)allyl groups and a (meth)acrylate group. A crosslinking monomer of this type is commercially available from Sartomer (Exton, PA), under the trade designation “SR 523”. In some embodiments, the crosslinking monomer is free of (meth)acrylate groups. The lower reactivity of the (meth)allyl group, as compared to a (meth)acrylate group, can be amendable to achieving an optimal amount of crosslinking, especially when the adhesive is cured by (e.g., UV) radiation.

The crosslinking monomer typically has the formula:

(H₂C═C(R¹)(CH₂)_{y})ₓZ

wherein R¹ is hydrogen or methyl, Z is a heteroatom or multivalent linking group, and x ranges from 2 to 6. In some embodiments, y is 5-20. In some embodiments, x is 2 or 3. For embodiments wherein the crosslinking monomer comprises a multivalent linking group, the linking group, Z, typically has a molecular weight no greater than 1000 g/mole and in some embodiments no greater than 500 g/mole, 400 g/mole, 300 g/mole, 200 g/mole, 100 g/mole, or 50 g/mole.

Various crosslinking monomers comprising at least two allyl and/or (meth)allyl groups are commercially available. Although these species comprise allyl groups, in many embodiments the same species with (meth)allyl groups are available or can be synthesized. For example, (meth)allyl adipate can be prepared in the manner described in U.S. Patent Pub. 2017/0037282 (Lipscomb et al.).

Useful acylphospine oxide photoinitiators may include, for example, diphenyl (2,4,6-trimethylbenzoyl) phosphine oxide (“TPO”) commercially available from IGM Resins USA Inc., Charlotte, North Carolina and phenylbis(2,4,6-trimethylbenzoyl) phosphineoxide (“BAPO”), both commercially available from IGM Resins USA Inc., Charlotte, North Carolina. In preferred embodiments, the crosslinkable composition comprises 0.05 pph to 5 pph (e.g., 1 pph) of the acylphosphine oxide photoinitiator with respect to the (meth)acrylate polymer mixture.

Additional details and methods for making such optically clear adhesives may be found in co-owned PCT Application Publication No. WO 2022/243801 (Kim et al.).

In select embodiments, the optically clear adhesive comprises a crosslinkable composition comprising:
a) a (meth)acrylate polymer, wherein the polymer has a glass transition temperature no greater than 30° C.;
b) a crosslinking agent, the crosslinking agent comprising a photo-active Type II photoinitiator and a polymerizable group selected from the group consisting of (meth)acrylate, allyl, and combinations thereof;
c) optionally an acid generator; and
d) a UV absorbing material represented by the structure:

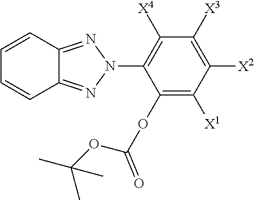

wherein: each of X¹, X², X³, and X⁴ is independently a hydrogen atom, a hydrocarbyl group including 1 to 15 carbon atoms, preferably 12 carbon atoms, or a heterohydrocarbyl group including 1 to 15 carbon atoms, preferably 12 carbon atoms.

Additional details and methods for making such optically clear adhesives may be found in co-owned PCT Application Number PCT/IB2022/062645 (Kim et al.).

Typically, the release liner exhibits a release force (from the optically clear adhesive) of 100 grams per 25 millimeters or less (g/25 mm), 50 g/25 mm, 25 g/25 mm, 15 g/25 mm, or even 10 g/25 mm or less, at a peel speed of 12 inches per minute (30.48 centimeters per minute). Such release forces may be useful for easy stripping off of the release liner and integration of the adhesive into an article. It is appreciated that different types of adhesive articles may be designed to have different preferred release properties. Release force may be measured using the test method described below in the Examples.

The above-described optically clear adhesives are typically coated on a release liner using conventional coating techniques modified as appropriate to the particular substrate. For example, these adhesives can be applied to a variety of release liners by methods such as stencil printing, screen printing, roller coating, flow coating, dip coating, spin coating, spray coating, knife coating, and die coating. These various methods of coating allow the optically clear adhesives to be placed on the release liner at variable thicknesses thus allowing a wider range of use of the adhesive articles.

### Exemplary Embodiments

In a first embodiment, the present disclosure provides a release liner. The release liner comprises a substrate having a first major surface and an opposing second major surface and a release coating disposed on at least a portion of the first major surface of the substrate. The release liner transmits at an incident light angle of at least one of 0°, 15°, 30°, 45°, 60°, or 75°, a greater average of incident light over a wavelength range from 470 nanometers (nm) to 530 nm than over a wavelength range from 400 nm to 460 nm.

In a second embodiment, the present disclosure provides a release liner according to the first embodiment, wherein the substrate comprises a polymeric film.

In a third embodiment, the present disclosure provides a release liner according to the first embodiment or the second embodiment, wherein the substrate comprises polyimide, polyethylene terephthalate (PET), polypropylene (PP), biaxially oriented polypropylene (BOPP), polyethylene (PE), polylactic acid (PLA), polymethyl methacrylate (PMMA), polyethylene naphthalate (PEN), polyurethane, polyvinyl chloride (PVC), polyvinyl alcohol (PVA), polyvinyl butyral, cellulose acetate, or any combination thereof.

In a fourth embodiment, the present disclosure provides a release liner according to any of the first through third embodiments, further comprising a photoabsorber additive either incorporated into the substrate or present in a coating on the second major surface of the substrate. In a fifth embodiment, the present disclosure provides a release liner according to the fourth embodiment, wherein the photoabsorber additive comprises a dye, a pigment, a red shifted ultraviolet absorber, nanoparticles, or any combination thereof.

In a sixth embodiment, the present disclosure provides a release liner according to any of the first through fifth embodiments, wherein the release coating comprises a material selected from the group consisting of a fluorine-containing material, a silicone-containing material, a fluoropolymer, a silicone polymer, a fluorosilicone polymer, and a poly(meth)acrylate ester derived from a monomer including an alkyl (meth)acrylate having an alkyl group with 12 to 36 carbon atoms.

In a seventh embodiment, the present disclosure provides a release liner according to any of the first through sixth embodiments, which absorbs at an incident light angle of at least one of 0°, 15°, 30°, 45°, 60°, or 75°, an average of at least 10% of incident light over a wavelength range from at least 400 nm to 450 nm.

In an eighth embodiment, the present disclosure provides a release liner according to any of the first through seventh embodiments, wherein the release liner transmits at an incident light angle of at least one of 0°, 15°, 30°, 45°, 60°, or 75°, an average of at least 30 percent of incident light over a wavelength range from 500 nanometers (nm) to 595 nm and an average of at most 90 percent of incident light over a wavelength range of 400 nm to 450 nm.

In a ninth embodiment, the present disclosure provides an adhesive article. The adhesive article comprises a release liner according to any of the first through eighth embodiments and an optically clear adhesive disposed on at least a portion of the release liner.

In a tenth embodiment, the present disclosure provides an adhesive article according to the ninth embodiment, wherein the optically clear adhesive further comprises a UV absorber.

In an eleventh embodiment, the present disclosure provides an adhesive article according to the ninth embodiment or the tenth embodiment, wherein the optically clear adhesive further comprises a photoinitiator that is activated at exposure to light in a wavelength range of 400 nm to 460 nm.

In a twelfth embodiment, the present disclosure provides an adhesive article according to any of the ninth through eleventh embodiments, wherein the optically clear adhesive comprises a (meth)acrylate copolymer and a reactive crosslinker.

In a thirteenth embodiment, the present disclosure provides an adhesive article according to the twelfth embodiment, wherein the (meth)acrylate copolymer has pendant (meth)acryloyl groups and optionally pendant hydroxyl groups.

In a fourteenth embodiment, the present disclosure provides an adhesive article according to the ninth embodiment, wherein the optically clear adhesive comprises a crosslinkable composition comprising a (meth)acrylate polymer comprising an alkyl (meth)acrylate monomer; an acylphosphine oxide photoinitiator; and a crosslinking monomer, the crosslinking monomer comprising at least two terminal groups selected from the group consisting of allyl, methallyl, or combinations thereof.

In a fifteenth embodiment, the present disclosure provides an adhesive article according to the ninth embodiment, wherein the optically clear adhesive comprises a crosslinkable composition comprising a (meth)acrylate polymer that has a glass transition temperature no greater than 30° C.; a crosslinking agent comprising a photo-active Type II photoinitiator and a polymerizable group selected from the group consisting of (meth)acrylate, allyl, and combinations thereof; optionally an acid generator; and a UV absorbing material represented by the structure:

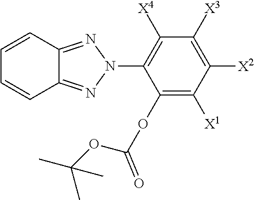

wherein: each of X¹, X², X³, and X⁴ is independently a hydrogen atom, a hydrocarbyl group including 1 to 15 carbon atoms, preferably 12 carbon atoms, or a heterohydrocarbyl group including 1 to 15 carbon atoms, preferably 12 carbon atoms.

In a sixteenth embodiment, the present disclosure provides an adhesive article according to any of the ninth through fifteenth embodiments, wherein the optically clear adhesive is a pressure-sensitive adhesive.

In a seventeenth embodiment, the present disclosure provides an adhesive article according to any of the ninth through sixteenth embodiments, wherein the optically clear adhesive has a haze value of less than 5%, less than 2%, or less than 1% for a 0.1 mm thick coating.

In an eighteenth embodiment, the present disclosure provides an adhesive article according to any of the ninth through seventeenth embodiments, wherein the release liner exhibits a release force of 100 grams per 25 millimeters or less (g/25 mm), 50 g/25 mm, 25 g/25 mm, 15 g/25 mm, or 10 g/25 mm or less, at a peel speed of 12 inches per minute (30.48 centimeters per minute).

In a nineteenth embodiment, the present disclosure provides an adhesive article according to any of the ninth through eighteenth embodiments, wherein the release liner is a first release liner and wherein the adhesive article further comprising a second release liner disposed on the optically clear adhesive opposite the first release liner.

In a twentieth embodiment, the present disclosure provides an adhesive article according to the nineteenth embodiment, wherein the second release liner is different from the first release liner.

In a twenty-first embodiment, the present disclosure provides an adhesive article according to the nineteenth embodiment, wherein the second release liner is according to any of the first through eighth embodiments.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

Unless otherwise noted or apparent from the context, all parts, percentages, ratios, etc. in the Examples and the rest of the specification are by weight. Table 1 (below) lists materials used in the examples and their sources.

Materials Used in the Examples

| Abbreviation | Description |
|---|---|
| TPO | Diphenyl(2,4,6-trimethylbenzoyl)phosphine oxide, obtained from IGM |
| | Resins USA Inc., Charlotte, North Carolina |
| I-819 | Phenylbis(2,4,6-trimethylbenzoyl)phosphineoxide, obtained from IGM |
| | Resins USA Inc., Charlotte, North Carolina |
| TINUVIN 928 | 2-(2H-Benzotriazol-2-yl)-6-(1-methyl-1-phenylethyl)-4-(1,1,3,3- |
| | tetramethylbutyl) phenol, obtained under the trade designation “TINUVIN |
| | 928” from BASF, Florham Park, New Jersey |
| SR351 | Trimethyloylpropane triacrylate, obtained as product number “SR351 H” |
| | from Sartomer USA, Exton, Pennsylvania |
| CN996 | Aliphatic urethane acrylate, obtained as product number “CN996” from |
| | Sartomer USA, Exton, Pennsylvania |
| IEM | 2-isocyanatoethyl methacrylate, can be obtained from Millipore Sigma, St. |
| | Louis, Missouri |
| VAZO 52 | 2,2′-azobix(2,4-dimethylpentanenitrile), obtained from DuPont, Wilmington, |
| | Delaware |
| PE1 | Pentaerythritol tetrakis(3-mercaptobutyrate), obtained from Showa Denko |
| | America Inc., New York, New York |
| nBA | n-butyl acrylate, obtained from BASF, Florham Park, New Jersey |
| EHMA | 2-ethylhexyl methacrylate, obtained from Lucite International, Memphis, |
| | Tennessee |
| HEA | Hydroxyethyl acrylate, obtained from KOWA American Corporation, New |
| | York, New York |
| AcM | Acrylamide, obtained from Alfa Aesar, Haverhill, Massachusetts |
| EtOAc | Ethyl acetate, obtained from EMD Millipore Corporation, Burlington, |
| | Massachusetts |
| V21 | Vinyl terminated polydimethylsiloxane, obtained as product code “DMS- |
| | V21” from Gelest, Morrisville, Pennsylvania |
| SYL-OFF 7488 | A liquid, reactive polysiloxane crosslinker, obtained under the trade |
| | designation “SYL-OFF 7488” from The Dow Chemical Company, Midland, |
| | Michigan |
| Pt Cat | Platinum-divinyltetramethyldisiloxane complex, 2.25 wt. % in xylene, |
| | obtained from Gelest, Morrisville, Pennsylvania |
| DAM | Diallyl maleate, obtained from Momentive Inc., Waterford, Pennsylvania |
| IPA | Isopropanol, obtained from VWR International, LLC, Radnor, Pennsylvania |
| MEK | Methyl ethyl ketone, can be obtained from VWR International, LLC, |
| | Radnor, Pennsylvania |
| PI Film | Dupont Kapton polyimide film, 50 μm, Lot D11261220, obtained from |
| | DuPont, Wilmington, Delaware |
| LED#1 | E2TBC-18F840D 2000 lumes 18W, obtained from Energetic Lighting, |
| | Chino, California |
| LED#2 | Osram L 18W/12 Lumilux de Luxe Tageslicht Daylight, obtained from |
| | Osram Sylvania, Wilmington, Massachusetts |
| RF02N | Silicone coated polyester release liner, 2 mil (51 micrometers) thick, |
| | available under the trade designation “RF02N” from SKC Haas Display |
| | Films LLC, Seoul KR |
| RF22N | Silicone coated PET release liner, 2 mil (51 micrometers) thick, available |
| | under the trade designation “RF22N” from SKC Haas Display Films LLC, |
| | Seoul KR, wherein the RF02N has a lower release force (i.e., easier to |
| | remove) than the RF22N. |

### Test Methods

### Optical Characterization Test

Transmission measurements were made using an ULTRASCANPRO Spectrophotometer (HunterLab, Reston, VA) in transmission mode. For measured samples, a 0.1 mm thick coated adhesive layer between release-coated carrier liners as described in the Examples below was cut to approximately 5 cm width by 10 cm length. One of the carrier liners was removed and the sample was laminated to a clear piece of 1 mm thick LCD glass (Swift Glass, Elmira Heights, New York). The second carrier liner was removed and the sample was placed in the ULTRASCANPRO Spectrophotometer to measure transmission and color through the glass/OCA assembly. Transmission at specific wavelengths were recorded and listed in Table 3 below.

### Gel Fraction Test

The gel fraction of the adhesive films was characterized by gravimetric methods. Circular samples of both polymerized as well as polymerized and cured adhesive films (thickness: 0.1 mm, sample diameter: 25 mm) were loaded in a porous stainless steel container (McMaster-Carr, Elmhurst, Illinois; mesh size: 0.5 mm, width×length×height: 40 mm×40 mm×30 mm) with known mass. The mesh container and adhesive film were weighed and then immersed in a glass jar (diameter×height: 70 mm×85 mm) comprising a 1:1 v/v mixture of ethyl acetate/isopropanol (about 60 mL). After 24 hours, the metallic container and remaining adhesive film were taken out of the solvent jar and dried in a convection oven (DESPATCH, Minneapolis, MN) at 120° C. for 3 hours to provide the adhesive film after solvent incubation and drying. The masses of the adhesive films before and after solvent-incubation were recorded after subtracting the mass of the empty cage from each value. Two gel fraction tests were run for each sample and the gel fraction values were averaged.

The gel fraction of each adhesive film was calculated as follows:

$$Gel Fraction = \frac{\begin{matrix}final mass of the adhesive \\ film after solvent incubation and drying\end{matrix}}{initial mass of the adhesive film}$$

### Molecular Weight Analysis Using GPC

The molecular weight distribution of the compounds was characterized using conventional gel permeation chromatography (GPC). The GPC instrumentation was obtained from Waters Corporation (Milford, MA), and included a high-pressure liquid chromatography pump (Model 1515HPLC), an auto-sampler (Model 717), a UV detector (Model 2487), and a refractive index detector (Model 2410). The chromatograph was equipped with two 5-micron PL gel MIXED-D columns obtained from Varian Inc. (Palo Alto, CA).

Samples of polymeric solutions were prepared by dissolving polymer or dried polymer samples in tetrahydrofuran at a concentration of 0.5 percent (weight/volume) and filtering through a 0.2-micron polytetrafluoroethylene filter that is available from VWR International (West Chester, PA). The resulting samples were injected into the GPC and eluted at a rate of 1 milliliter per minute through the columns maintained at 35° C. The system was calibrated with polystyrene standards using a linear-least squares analysis to establish a calibration curve. The weight average molecular weight (Mw) and the polydispersity index (weight average molecular weight (Mw) divided by number average molecular weight (Mn)) were calculated for each sample against this standard calibration curve.

Peel Force from Release Liner Test

Liner release force was tested by cutting a 1.27-centimeter-wide (½″) and approximately 10-centimeter-long sample of the test sample using a specimen razor cutter. The cut sample was applied lengthwise onto the platen surface of a peel adhesion tester (IMASS TL-2300 tester, obtained from IMASS, Inc., Accord, MA) using 3M Double Coated Paper Tape 410M (available from 3M Company, St. Paul, MN). The release liner was peeled from the adhesive at an angle of 180 degrees at either 30.5 cm/minute (12″/minute) or 228.6 cm/minute (90″/minute) and the release force was recorded by the adhesion peel tester. At least two specimens were tested for each release liner at each speed and the average release values were reported. Since the samples contained two release liners, the release liner with easier release force (RF02N for comparative examples) was tested first, while the tighter release liner (RF22N for comparative examples) was laminated to the 410M tape. After testing the easier release liner, an approximately 5.08-centimeter-wide and 15-centimeter long HOSTAPHAN 3SAC polyester film (available from Mitsubishi Polyester Film, Inc, Greer, SC) was laminated to the exposed adhesive using a hand roller. The sample was removed from the 410M tape and laminated to the platen surface of the peel tester using a new piece of 410M tape this time with the 3SAC polyester film facing down and the tighter release liner facing up, so it could be release tested.

### Preparatory Examples

### Prep EX 1

To a glass bottle were added nBA (78 g), EHMA (10 g), HEA (8.0 g), ACM (4.0 g), VAZO 52 (0.1 g), PE1 (0.2 g), and EtOAc (100 g). The contents were mixed and sparged with nitrogen for 2 minutes before being sealed and placed in a LAUNDER-OMETER rotating water bath (SDL Atlas, Rock Hill, SC, USA) for 24 hours at 60° C. After 24 hours the sample was removed from the LAUNDER-OMETER and cooled using ambient conditions. The sample was analyzed using GPC to determine that the Mw was 410 kDa. To this solution, IEM (0.25 g) was added and the jar was heated at approximately 60° C. for 24 hours using a jar rolling apparatus with fitted IR heat lamp.

### Prep EX 2

A 40 wt. % solids (dry solids) solution of V21 and SYL-OFF 7488 in heptane: MEK (80:20) was prepared. To the solution was added Pt Cat (120 ppm), and DAM (0.2 wt. %) inhibitor. The 40 wt. % solution was formulated at a hydride to vinyl ratio of 1.30 using an equivalent weight of 3,000 g/mole for V21 and 76 g/mole for SYL-OFF 7488. The 120 ppm Pt Cat and the 0.2 wt. % DAM inhibitor are based on the dry solids only (V21+SYL-OFF 7488).

After the solution was prepared, it was used within hours of being mixed. A #3 formed Mayer rod (available from RD Specialties Inc., Webster, New York) was used to coat the release formulation onto a 2 mil (50 um) polyimide film (Dupont Kapton, 50 μm, available from DuPont, Wilmington, Delaware) and the handspreads were thermally cured on open face boards in a solvent rated oven at for 30 seconds at 120° C. The solids and Mayer rod were picked to target a cured silicone release coating weight of about 1.0 grams per square meter. After 1 week of aging at 23° C. and 50% relative humidity, the handspreads were ready for use.

### EXAMPLES

Adhesive coatings (AD1 and AD2) were prepared utilizing the functionalized polymer from Prep EX 1. For AD1, 50 grams of the selected polymer solution of Prep EX 1 was place in a glass jar followed by CN996 (5.0 pph, relative to the total weight of the polymer in solution), SR351 (5.0 pph), I-819 (1.0 pph), TINUVIN 928 (2.0 pph), and methanol (2.0 pph). The were jars sealed and rolled for at least 12 hours using a jar roller prior to coating. For AD2, the same procedure as outlined above for AD1 was used except TPO (1.0 pph) was added in instead of I-819 (1.0 pph).

The sample solutions were coated via knife coater onto a 75 μm PET liner with release coating (RF22N) and dried for 5 minutes at room temperature, followed by 30 minutes at 70° C. The dry thickness of all the sample coatings was 100 μm±10 μm. Following drying, a second liner of either siliconized polyester film (RF02N) or the siliconized polyimide film from Prep EX 2 was laminated on top of the sample coatings. Optical measurements were taken for films laminated with either siliconized PET or siliconized PI as detailed in the Optical Characterization Test with results shown in Table 2 below.

TABLE 2
Optical Measurement of Liner and Adhesive
Construction on LCD Glass

| | | Transmission (%) at Wavelength | | | |
|---|---|---|---|---|---|
| Adhesive | Liner | 350 nm | 410 nm | 550 nm | 600 nm |
| AD1 | Prep EX 2 | 2.0 | 0.3 | 52.8 | 71.3 |
| AD1 | RF22N | 6.8 | 61.4 | 88.6 | 88.9 |

Liner release force with coated adhesive from Example 1 from either the siliconized PI film from Preparatory Example 1 or either of the siliconized PET liners was tested according to the Peel Force from Release Liner Test above and listed below in Table 3.

TABLE 3
Peel Force from Release Liner

| Adhesive | Liner | Release Force 12″/min | Release Force 90″/min |
|---|---|---|---|
| AD1 | Prep EX 2 | 3.6 | 5.7 |
| AD1 | RF02N | 1.3 | 5.0 |
| AD1 | RF22N | 7.1 | 15.9 |

Samples were then placed in aluminum trays with the RF02N liner downward and exposed to two different types of visible light sources while gel content measurements were taken at set periods of time as indicated in Tables 4 and 5 below. Gel content was tracked to determine if the exposure to ambient visible light elicited crosslinking reactions within the optical adhesive materials. For EX 1 and CE 1, samples were exposed to LED bulbs at a distance of approximately 60 cm for up to 10 hours. Table 4 depicts the gel content results for EX 1 that is covered by the liner from Prep EX 2, as well as CE 1, which is covered by the siliconized PET liner (RF22N).

TABLE 4
EX 1 and CE 1 under LED#1 Exposure

| | Gel Content (%) at Time (hr) | | | | | |
|---|---|---|---|---|---|---|
| Sample | 0 | 1 | 2.5 | 5 | 6.5 | 10 |
| Ex1 | 0.6% | 1% | 0.9% | 0.3% | 1.2% | 1.3% |
| CE1 | 0.6% | 65.4% | 74.3% | 79.6% | 82.3% | 82.8% |

Table 5 depicts the gel content results for EX 2 that is covered by the liner from Prep EX 2, as well as CE 2, which is covered by the siliconized PET liner (RF22N). For these Examples, LED source #2 was utilized at a distance of approximately 60 cm for up to 24 hours.

TABLE 5
EX 2 and CE 2 under LED#2 Exposure

| | Gel Content (%) at Time (hr) | | | | | |
|---|---|---|---|---|---|---|
| Sample | 0 | 1 | 5 | 8.5 | 15 | 24 |
| Ex2 | 1.8% | 2.3% | 1.1% | 3.0% | 2.8% | 1.5% |
| CE2 | 1.8% | 1.7% | 64.5% | 74.9% | 79.7% | 82.6% |

In both Tables 4 and 5, it was observed that the PI based release film allowed for protection against premature crosslinking from exposure to the various ambient light sources whereas the typical siliconized PET liner did not.

Foreseeable modifications and alterations of this invention will be apparent to those skilled in the art without departing from the scope and spirit of this invention. This invention should not be restricted to the embodiments that are set forth in this application for illustrative purposes.

1. A release liner comprising:
a) a substrate having a first major surface and an opposing second major surface; and
b) a release coating disposed on at least a portion of the first major surface of the substrate,
c) wherein either i) the substrate comprises polyimide or ii) a photoabsorber additive is either incorporated into the substrate or present in a coating on the second major surface of the substrate, or both i) and ii); and wherein the release liner transmits at an incident light angle of at least one of 0°, 15°, 30°, 45°, 60°, or 75°, a greater average of incident light over a wavelength range from 470 nanometers (nm) to 530 nm than over a wavelength range from 400 nm to 460 nm.

2. The release liner of claim 1, wherein the substrate comprises a polymeric film.

3. The release liner of claim 1, wherein the substrate comprises polyimide, polyethylene terephthalate (PET), polypropylene (PP), biaxially oriented polypropylene (BOPP), polyethylene (PE), polylactic acid (PLA), polymethyl methacrylate (PMMA), polyethylene naphthalate (PEN), polyurethane, polyvinyl chloride (PVC), polyvinyl alcohol (PVA), polyvinyl butyral, cellulose acetate, or any combination thereof.

4. The release liner of claim 1, further comprising the photoabsorber additive either incorporated into the substrate or present in the coating on the second major surface of the substrate.

5. The release liner of claim 4, wherein the photoabsorber additive comprises a dye, a pigment, a red shifted ultraviolet absorber, nanoparticles, or any combination thereof.

6. An adhesive article comprising:
a) a release liner according to claim 1; and
b) an optically clear adhesive disposed on at least a portion of the release liner.

7. The adhesive article of claim 6, wherein the optically clear adhesive further comprises a UV absorber.

8. The adhesive article of claim 6, wherein the optically clear adhesive further comprises a photoinitiator that is activated at exposure to light in a wavelength range of 400 nm to 460 nm.

9. The adhesive article of claim 6, wherein the optically clear adhesive comprises a (meth)acrylate copolymer and a reactive crosslinker.

10. The adhesive article of claim 9, wherein the (meth)acrylate copolymer has pendant (meth)acryloyl groups and optionally pendant hydroxyl groups.

11. The adhesive article of claim 6, wherein the optically clear adhesive comprises a crosslinkable composition comprising:
a) a (meth)acrylate polymer comprising an alkyl (meth)acrylate monomer;
b) an acylphosphine oxide photoinitiator; and
c) a crosslinking monomer, the crosslinking monomer comprising at least two terminal groups selected from the group consisting of allyl, methallyl, or combinations thereof.

12. The adhesive article of claim 6, wherein the optically clear adhesive comprises a crosslinkable composition comprising:
a) a (meth)acrylate polymer, wherein the polymer has a glass transition temperature no greater than 30° C.;
b) a crosslinking agent, the crosslinking agent comprising a photo-active Type II photoinitiator and a polymerizable group selected from the group consisting of (meth)acrylate, allyl, and combinations thereof;
c) optionally an acid generator; and
d) a UV absorbing material represented by the structure 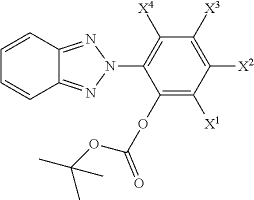
wherein:
each of X¹, X², X³, and X⁴ is independently a hydrogen atom, a hydrocarbyl group including 1 to 15 carbon atoms, or a heterohydrocarbyl group including 1 to 15 carbon atoms.

13. The adhesive article of claim 6, wherein the optically clear adhesive is a pressure-sensitive adhesive.

14. The adhesive article of claim 6, wherein the release liner exhibits a release force of 100 grams per 25 millimeters or less (g/25 mm), 50 g/25 mm, 25 g/25 mm, 15 g/25 mm, or 10 g/25 mm or less, at a peel speed of 12 inches per minute (30.48 centimeters per minute).

15. The adhesive article of claim 6, wherein the release liner is a first release liner and wherein the adhesive article further comprising a second release liner disposed on the optically clear adhesive opposite the first release liner.

16. The adhesive article of claim 15, wherein the second release liner is different from the first release liner.

17. The adhesive article of claim 15, wherein the second release liner is according to claim 1.
